(19) United States
(12) Patent Application Publication
(10) Pub. No.: US 2016/0185037 A1
(43) Pub. Date: Jun. 30, 2016

(54) Method for Manufacturing a Composite Resilient Product that is Selected from Thermosetting Material and Thermoplastic Material

(71) Applicant: SIMPLE TEK CORP., Huatan Township (TW)

(72) Inventor: Chen-I Kao, Huatan Township (TW)

(21) Appl. No.: 14/975,909

(22) Filed: Dec. 21, 2015

(30) Foreign Application Priority Data
Dec. 26, 2014 (TW) 103145612

(51) Int. Cl. B29C 65/00; B29C 65/08

(52) U.S. Cl. CPC B29C 66/712; B29C 65/08; B29C 66/45; B29K 2021/00

(57) ABSTRACT

A method includes selecting a primary staple from thermosetting material and thermoplastic material. Then, a pressure is applied so that the thermosetting material and the thermoplastic material present a sheet state. Then, the thermosetting material and the thermoplastic material are laminated and heated. After the thermoplastic material is heated at a high temperature, thermoplastic resin molecules in the thermoplastic material are activated, and the distance between the thermoplastic resin molecules is increased to present a medium layer which is moved to intertwine the thermosetting material and the thermoplastic material. Then, the thermoplastic resin molecules between the thermosetting material and the thermoplastic material are fused by a pressing operation so that the thermosetting material and the thermoplastic material are combined together. Finally, the thermoplastic resin molecules are cooled and cured to obtain a composite resilient product including the thermosetting material and the thermoplastic material.

### BACKGROUND OF THE INVENTION

1. Field of the Invention

The present invention relates to a method for manufacturing a composite resilient product and, more particularly, to a method for manufacturing a composite resilient product that is selected from thermosetting material and thermoplastic material.

2. Description of the Related Art

A first conventional method for making a rubber (including natural or synthetic rubber) foam product is a successive extruding method which comprises milling a rubber staple, then extruding the rubber staple by an extruding machine to form a rubber sheet, and then delivering the rubber sheet into a vulcanization molding machine so that the rubber sheet is vulcanized and foamed to form a rubber foam product. A second conventional method for making a rubber foam product is a hot press molding method which comprises using a press die to heat and press a rubber staple so as to form a rubber foam product. A decorative item is bonded onto the surface of the rubber foam product to enhance the aesthetic quality of the rubber foam product so as to attract the consumer. The decorative item is preferably a heterogeneous foam material or plastic skin. The decorative item is bonded onto the surface of the rubber foam product by a gel or bonding agent. However, using the gel or bonding agent will pollute the air and water to cause an environmental problem. In addition, the amount of the gel or bonding agent is not controlled easily and precisely, the thickness of the gel or bonding agent is not distributed evenly and smoothly, thereby affecting the heterogeneous combination of the decorative item and the rubber foam product.

### BRIEF SUMMARY OF THE INVENTION

The primary objective of the present invention is to provide a method for manufacturing a successive thermosetting and thermoplastic composite resilient product that is selected from thermosetting material and thermoplastic material.

In accordance with the present invention, there is provided a method for manufacturing a composite resilient product, comprising a step a) of preparing a staple: selecting a primary staple from thermosetting material and thermoplastic material; a step b) of compressing: applying a determined pressure on the thermosetting material and the thermoplastic material by a compression device so that the thermosetting material and the thermoplastic material present a sheet state; a step c) of laminating: mutually laminating the thermosetting material and the thermoplastic material each of which has a sheet shape; a step d) of fusing: heating the thermosetting material and the thermoplastic material so that after the thermoplastic material is heated at a high temperature, the thermoplastic material contains thermoplastic resin molecules which are activated to increase a distance between the thermoplastic resin molecules and to present a medium layer, wherein the medium layer of the thermoplastic resin molecules is moved to intertwine the thermosetting material and the thermoplastic material; a step e) of pressing: performing a pressing operation to mutually fuse the thermoplastic resin molecules between the thermosetting material and the thermoplastic material so that the thermosetting material and the thermoplastic material are combined together; and a step f) of cooling: performing a cooling operation by a cooling device so that the thermoplastic resin molecules between the thermosetting material and the thermoplastic material are cured to obtain a composite resilient product including the thermosetting material and the thermoplastic material.

According to the primary advantage of the present invention, the thermosetting material and the thermoplastic material are directly combined together by compressing, laminating, fusing, pressing and cooling, so that the method combines the thermosetting material and the thermoplastic material of two heterogeneous features without needing any gel or bonding agent.

According to another advantage of the present invention, all of the steps, except the first step of preparing a staple, of the method are performed automatically, so that the composite resilient product is fabricated easily and quickly in a precise and stable manner.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a flow chart of a method for manufacturing a composite resilient product in accordance with the preferred embodiment of the present invention.

FIG. 2 is a flow chart showing details of the steps of the method as shown in FIG. 1.

FIG. 3 is another flow chart of the method for manufacturing a composite resilient product in accordance with the preferred embodiment of the present invention.

FIG. 4 is a flow chart showing details of the steps of the method as shown in FIG. 3.

### DETAILED DESCRIPTION OF THE INVENTION

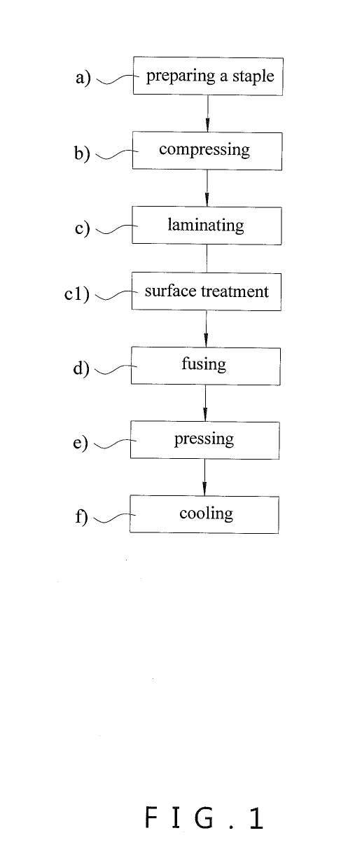

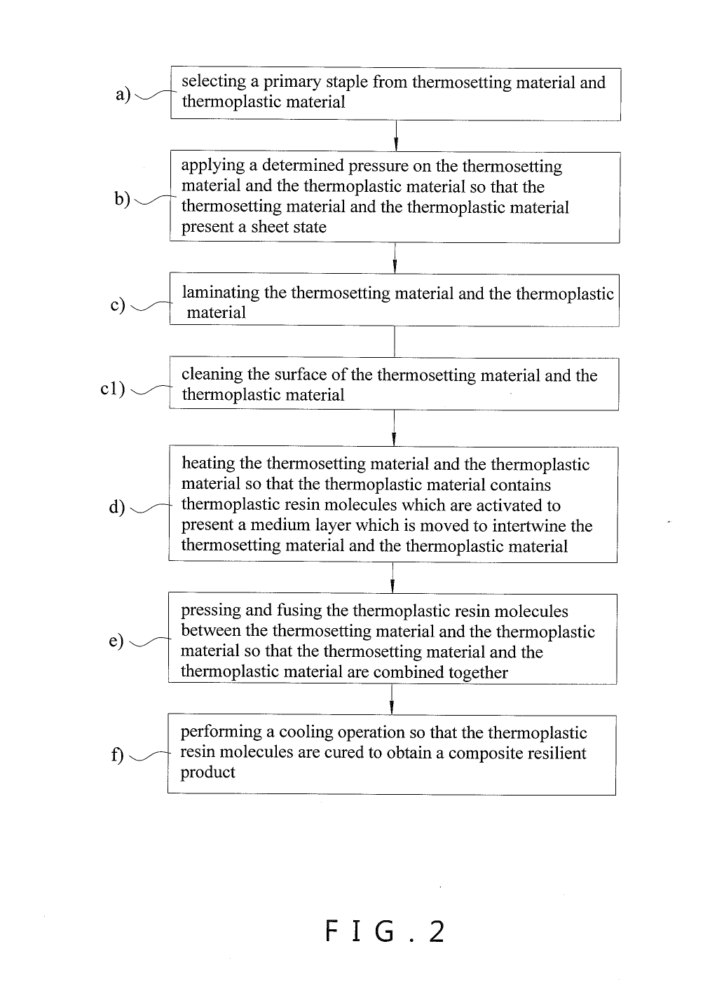

Referring to the drawings and initially to FIGS. 1 and 2, a method for manufacturing a composite resilient product in accordance with the present invention comprises a step a) of preparing a staple: selecting a primary staple from thermosetting material and thermoplastic material; a step b) of compressing: applying a determined pressure on the thermosetting material and the thermoplastic material by a compression device so that the thermosetting material and the thermoplastic material present a sheet state; a step c) of laminating: mutually laminating the thermosetting material and the thermoplastic material each of which has a sheet shape; a step d) of fusing: heating the thermosetting material and the thermoplastic material so that after the thermoplastic material is heated at a high temperature, the thermoplastic material contains thermoplastic resin molecules which are activated to increase a distance between the thermoplastic resin molecules and to present a medium layer, wherein the medium layer of the thermoplastic resin molecules is moved to intertwine the thermosetting material and the thermoplastic material; a step e) of pressing: performing a pressing operation to mutually fuse the thermoplastic resin molecules between the thermosetting material and the thermoplastic material so that the thermosetting material and the thermoplastic material are combined together; and a step f) of cooling: performing a cooling operation by a cooling device so that the thermoplastic resin molecules between the thermosetting material and the thermoplastic material are cured to obtain a composite resilient product including the thermosetting material and the thermoplastic material.

In the step a), the thermosetting material is made of a rubber, and the thermoplastic material is made of polyethylene.

In the preferred embodiment of the present invention, between the step c) and the step d), the method further comprises a step c1) of surface treatment: performing a surface treatment to clean a surface of the thermosetting material and the thermoplastic material.

In the step d), the thermosetting material and the thermoplastic material are heated by a resistance heating device, an ultrasonic device or a sensitive heating device.

In conclusion, the method for manufacturing a composite resilient product in accordance with the present invention is described as follows. First of all, a primary staple is selected from thermosetting material and thermoplastic material. Then, a compression device applies a determined pressure on the thermosetting material and the thermoplastic material so that the thermosetting material and the thermoplastic material present a sheet state. Then, the thermosetting material and the thermoplastic material are laminated.

Then, the thermosetting material and the thermoplastic material are heated. After the thermoplastic material is heated at a high temperature, thermoplastic resin molecules in the thermoplastic material are activated, and the distance between the thermoplastic resin molecules is increased to present a medium layer. Thus, the medium layer of the thermoplastic resin molecules is moved to intertwine the thermosetting material and the thermoplastic material. Then, a pressing operation is performed to fuse the thermoplastic resin molecules between the thermosetting material and the thermoplastic material so that the thermosetting material and the thermoplastic material are combined together. Finally, a cooling operation is performed so that the thermoplastic resin molecules between the thermosetting material and the thermoplastic material are cured to obtain a composite resilient product including the thermosetting material and the thermoplastic material.

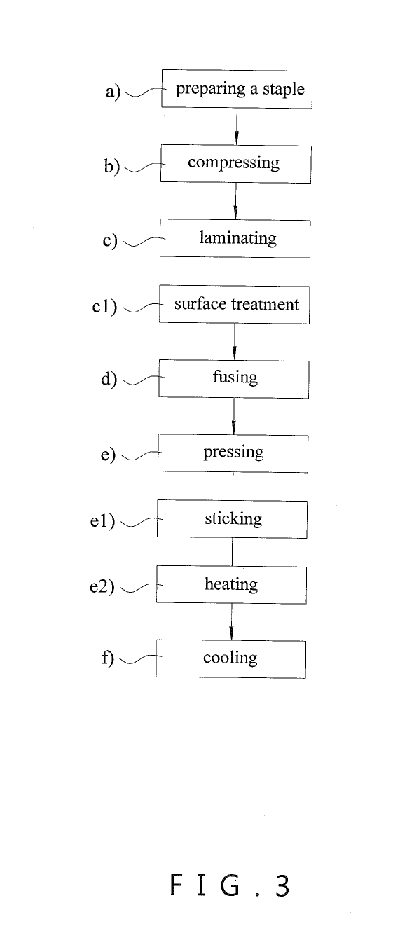

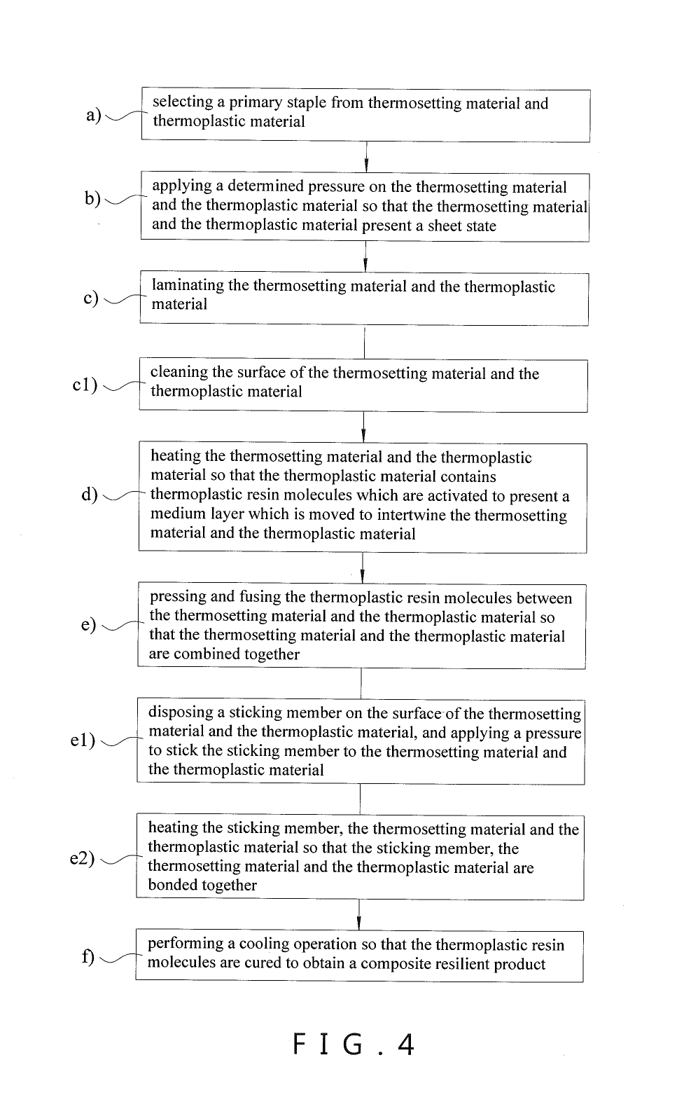

Referring to FIGS. 3 and 4 with reference to FIGS. 1 and 2, between the step e) and the step f), the method further comprises a step e1) of sticking: disposing a sticking member on the surface of the thermosetting material and the thermoplastic material, and applying a pressure to stick the sticking member to the thermosetting material and the thermoplastic material.

After the step e1), the method further comprises a step e2) of heating: performing a heating operation to the sticking member, the thermosetting material and the thermoplastic material so that the sticking member, the thermosetting material and the thermoplastic material are bonded together.

Preferably, the heating operation applied on the sticking member, the thermosetting material and the thermoplastic material is performed by a heating device.

Preferably, the heating device is an oven or a vulcanization molding machine.

Preferably, the sticking member is selected from rubber, plastic material or cloth.

Accordingly, the thermosetting material and the thermoplastic material are directly combined together by compressing, laminating, fusing, pressing and cooling, so that the method combines the thermosetting material and the thermoplastic material of two heterogeneous features without needing any gel or bonding agent. In addition, all of the steps, except the first step of preparing a staple, of the method are performed automatically, so that the composite resilient product is fabricated easily and quickly in a precise and stable manner.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A method for manufacturing a composite resilient product, comprising:
a step a) of preparing a staple: selecting a primary staple from thermosetting material and thermoplastic material;
a step b) of compressing: applying a determined pressure on the thermosetting material and the thermoplastic material by a compression device so that the thermosetting material and the thermoplastic material present a sheet state;
a step c) of laminating: mutually laminating the thermosetting material and the thermoplastic material each of which has a sheet shape;
a step d) of fusing: heating the thermosetting material and the thermoplastic material so that after the thermoplastic material is heated at a high temperature, the thermoplastic material contains thermoplastic resin molecules which are activated to increase a distance between the thermoplastic resin molecules and to present a medium layer, wherein the medium layer of the thermoplastic resin molecules is moved to intertwine the thermosetting material and the thermoplastic material;
a step e) of pressing: performing a pressing operation to mutually fuse the thermoplastic resin molecules between the thermosetting material and the thermoplastic material so that the thermosetting material and the thermoplastic material are combined together; and
a step f) of cooling: performing a cooling operation by a cooling device so that the thermoplastic resin molecules between the thermosetting material and the thermoplastic material are cured to obtain a composite resilient product including the thermosetting material and the thermoplastic material.

2. The method for manufacturing a composite resilient product of claim 1, wherein in the step a), the thermosetting material is made of a rubber, and the thermoplastic material is made of polyethylene.

3. The method for manufacturing a composite resilient product of claim 1, wherein between the step c) and the step d), the method further comprises a step c1) of surface treatment: performing a surface treatment to clean a surface of the thermosetting material and the thermoplastic material.

4. The method for manufacturing a composite resilient product of claim 1, wherein in the step d), the thermosetting material and the thermoplastic material are heated by a resistance heating device, an ultrasonic device or a sensitive heating device.

5. The method for manufacturing a composite resilient product of claim 1, wherein between the step e) and the step f), the method further comprises a step e1) of sticking: disposing a sticking member on the surface of the thermosetting material and the thermoplastic material, and applying a pressure to stick the sticking member to the thermosetting material and the thermoplastic material.

6. The method for manufacturing a composite resilient product of claim 5, wherein after the step e1), the method further comprises a step e2) of heating: performing a heating operation to the sticking member, the thermosetting material and the thermoplastic material so that the sticking member, the thermosetting material and the thermoplastic material are bonded together.

7. The method for manufacturing a composite resilient product of claim 6, wherein the heating operation applied on the sticking member, the thermosetting material and the thermoplastic material is performed by a heating device.

8. The method for manufacturing a composite resilient product of claim 7, wherein the heating device is an oven or a vulcanization molding machine.

9. The method for manufacturing a composite resilient product of claim 7, wherein the sticking member is selected from rubber, plastic material or cloth.
